(19) United States
(12) Patent Application Publication
(10) Pub. No.: US 2024/0361540 A1
(43) Pub. Date: Oct. 31, 2024

(54) CONNECTOR ASSEMBLY

(71) Applicant: Molex, LLC, Lisle, IL (US)

(72) Inventors: Ming-Huei Kao, New Taipei City (TW); Tsai-Hui Chien, Taipei City (TW)

(21) Appl. No.: 18/646,904

(22) Filed: Apr. 26, 2024

(30) Foreign Application Priority Data
Apr. 26, 2023 (CN) 202310462765.6
Feb. 7, 2024 (CN) 202410174237.5

(51) Int. Cl. G02B 6/38; H01R 13/6587

(52) U.S. Cl. CPC G02B 6/3897; G02B 6/3893; H01R 13/6587

(57) ABSTRACT

A connector assembly includes a guiding shield cage, a side cover plate, a light guide member and a first assembling construction. The guiding shield cage has a side wall. The side cover plate is assembled to the side wall of the guiding shield cage. The light guide member has a plurality of light guiding pipes. Each light guiding pipe has a light inputting end and a light outputting end. The light guide member is assembled on the side cover plate. The first assembling construction is provided between the light guide member and the side cover plate and is used to assemble the light guide member on the side cover plate. By that the light guide member and the side cover plate are provided therebetween with the first assembling construction which allows the light guide member and the side cover plate to cooperate with each other, the light guide member and the base seat are capable of being stably and indeed fixed on the side cover plate

### TECHNICAL FIELD

The present disclosure relates to a connector assembly, and particularly relates to a connector assembly which has a light guide member.

### BACKGROUND

Chinese patent document CN110364871B (corresponding to United State patent U.S. Pat. No. 10,950,983B2) discloses a side wall of a cage and light guiding pipes are formed thereon with a latching structure, the latching structure includes a first latching structure which is adapted to position the light guiding pipes in a vertical direction and a second latching structure which is adapted to position the light guiding pipes in a horizontal direction. The first latching structure includes a first connecting post which extends along the horizontal direction and is connected between the two corresponding adjacent light guiding pipes and a first latching member which has a first C-shaped latching groove adapted to latch over the first connecting post. The second latching structure includes a second connecting post which extends along the vertical direction and is connected between the two corresponding adjacent light guiding pipes and a second latching member which has a second C-shaped latching groove adapted to latch over the second connecting post.

However, the first latching member and the second latching member are stamped members which are formed by stamping the side wall of the cage, that is, it needs to stamp apertures on the side wall of the cage to form the latching members, these apertures will lower an electromagnetic interference suppressing effect of the cage. In addition, the latching member and the connecting post latch with each other therebetween only by means of the C-shaped latching groove, an assembling structure is not sufficient in strength and thus is not firm. Moreover, the light guiding pipes need to be sideward assembled or detached, a space needs to be reserved at a side surface of the cage, when it is applied to a combination that guiding shield cages are arranged side by side, only it needs increase a sideward arrangement pitch of the guiding shield cages, can the light guiding pipes have a sufficient space to be sideward assembled or detached. Although the light guiding pipes are assembled before the guiding shield cages are arranged side by side in some cases, such an assembling structure will still make that the corresponding light guiding pipes cannot be detached after all the assembling operations are completed.

### SUMMARY

Therefore, an object of the present disclosure is to provide a connector assembly which can improve at least one problem of prior art.

Accordingly, in some embodiments, a connector assembly of the present disclosure comprises a guiding shield cage, a side cover plate, a light guide member and a first assembling construction. The guiding shield cage has a side wall. The side cover plate is assembled to the side wall of the guiding shield cage. The light guide member has a plurality of light guiding pipes. Each light guiding pipe has a light inputting end and a light outputting end. The light guide member is assembled on the side cover plate. The first assembling construction is provided between the light guide member and the side cover plate and is used to assemble the light guide member on the side cover plate.

In some embodiments, the first assembling construction has an inserting construction and a clipping construction.

In some embodiments, the inserting construction has an inserting rod which is provided to the light guide member, and an inserting rod receiving groove which is formed to the side cover plate and is used to receive the inserting rod.

In some embodiments, the light guide member further has a connecting rod which is connected between the plurality of light guiding pipes; the inserting rod is provided on the connecting rod of the light guide member; the side cover plate is constructed with a sideward protruding piece which extends outwardly, the sideward protruding piece and a body of the side cover plate therebetween constitute the inserting rod receiving groove.

In some embodiments, the clipping construction has a positioning block, a position-limiting block and a supporting block which are provided on the light guide member, and a positioning recess and a position-limiting groove which are provided on the side cover plate; the positioning block is received in the positioning recess, the position-limiting block inserts into the position-limiting groove, the supporting block is supported on the side cover plate.

In some embodiments, the light guide member further has a connecting rod which is connected between the plurality of light guiding pipes; the positioning block, the position-limiting block and the supporting block are provided to the connecting rod of the light guide member which is close to the light outputting ends, the positioning block protrudes toward the side cover plate, above and below the positioning block each are provided with the position-limiting block which extends toward the front, the supporting block extends rearwardly.

In some embodiments, the side cover plate is constructed with a U-shaped protrusion which is opened upwardly, and a bulge which is positioned above the U-shaped protrusion, the U-shaped protrusion and the bulge therebetween constitute the positioning recess; the side cover plate comprises position-limiting pieces which extend outwardly and rearwardly, the position-limiting pieces and the body of the side cover plate therebetween constitute the position-limiting grooves.

In some embodiments, the connector assembly further comprises a base seat and a second assembling construction, the base seat is assembled on the light guide member, the base seat has a plurality of light guiding pipe receiving holes, the plurality of light guiding pipe receiving holes are respectively used to receive the light inputting ends of the plurality of light guiding pipes; the second assembling construction is provided between the light guide member and the base seat.

In some embodiments, the second assembling construction comprises a latching block which is provided on the light guide member, and a latching groove which is provided on the base seat and is used to latch with the latching block.

In some embodiments, the light guide member further has connecting rods which are connected between the plurality of light guiding pipes; the latching block is provided on the connecting rod of the light guide member which is close to the light inputting ends, the latching block extends downwardly and has a latching hook which is positioned to a tip of the latching block; the latching groove is provided therein with a latching hook cooperating portion which cooperates with the latching hook.

In some embodiments, the connector assembly further comprises a third assembling construction, the base seat is assembled to the side cover plate, the third assembling construction is provided between the base seat and the side cover plate.

In some embodiments, the third assembling construction comprises a retaining groove which is provided to the base seat, and a retaining portion which is provided to the side cover plate and is used to insert into the retaining groove.

In some embodiments, an opening of the retaining groove is positioned to a bottom surface of the base seat and the retaining groove extends upwardly from the opening;
the retaining portion upwardly extends to an outer side of a body of the side cover plate, and the retaining portion has an interfering protrusion which cooperates with the retaining groove by interference.

In some embodiments, the first assembling construction has an interference cooperating construction and an elastic latching construction.

In some embodiments, the interference cooperating construction has a retaining hole which is formed to the light guide member, and a retaining piece which is provided to the side cover plate, in an assembling direction that the light guide member faces the side cover plate, the retaining piece is fixed in the retaining hole by interference cooperation.

In some embodiments, a side edge of the retaining piece has a front protruding portion and a recessed portion which is positioned behind the front protruding portion, the retaining hole therein has an internal protruding portion which cooperates with the recessed portion of the side edge of the retaining piece, the front protruding portion interferes with the internal protruding portion in the retaining hole in an inserting process of the retaining piece.

In some embodiments, the side edge of the retaining piece further has a rear protruding portion which is positioned behind the recessed portion, the recessed portion is positioned between the front protruding portion and the rear protruding portion.

In some embodiments, the elastic latching construction has a latch block which is provided to the light guide member, and a latch piece which is provided to the side cover plate and is elastic, in the assembling direction that the light guide member faces the side cover plate, the latch piece latches the latch block.

In some embodiments, the light guide member further has a supporting portion which is integrally connected to the plurality of light guiding pipes, the supporting portion of the light guide member is formed with the retaining hole and the latch block.

In some embodiments, the supporting portion comprises a supporting rod and a plurality of connecting rods connected to the plurality of light guiding pipes, the supporting rod of the light guide member is formed with the retaining hole, and allows the latch block to be provided thereon.

In some embodiments, the latch piece has a latch hole which is used to latch the latch block.

In some embodiments, a side of the latch block which faces the latch piece is provided with a guiding surface, a side of the latch piece which faces the latch block is provided with a guiding edge which cooperates with the guiding surface.

In some embodiments, the connector assembly further comprises a base seat and a second assembling construction, the base seat comprises a plurality of light guiding pipe receiving holes, the plurality of light guiding pipe receiving holes are respectively used to receive light inputting ends of the plurality of the light guiding pipes; the second assembling construction is provided between the light guide member and the base seat.

In some embodiments, the second assembling construction comprises a plurality of latching blocks which are respectively provided to the light inputting ends of the plurality of the light guiding pipes, and a plurality of latching grooves which are respectively formed to inner walls of the plurality of light guiding pipe receiving holes of the base seat, the plurality of latching blocks respectively latch the plurality of the latching groove.

In some embodiments, the guiding shield cage further comprises an assembling piece which protrudes from the side wall, the side cover plate has an assembling hole, the assembling piece passes through the assembling hole of the side cover plate, and latches the side cover plate.

In some embodiments, the guiding shield cage further comprises a partitioning frame, the partitioning frame has the assembling piece, the side wall has an assembling hole, the assembling hole of the side cover plate corresponds to the assembling hole of the side wall, the assembling piece outwardly and sequentially passes through the assembling hole of the side wall and the assembling hole of the side cover plate, and latches the side cover plate.

In some embodiments, the base seat of material is a soft material containing a rubber.

The beneficial effect of the present disclosure of lies in that: by that the light guide member is provided on the side cover plate, the corresponding side wall of the guiding shield cage does not need a construction and apertures which are used to assemble the light guiding pipe, at the same time by that the side cover plate is assembled to the corresponding side wall of the guiding shield cage, the side cover plate is capable of covering some openings or opened holes on the side wall, the side cover plate has a double technical effect of both an electromagnetic interference (EMI) shielding function and being used to assemble the light guide member. Moreover, by that the light guide member and the side cover plate are provided therebetween with the first assembling construction which allows the light guide member and the side cover plate to cooperate with each other and the light guide member and the base seat are provided therebetween with the second assembling construction which allows the light guide member and the base seat to cooperate with each other, the light guide member and the base seat are capable of being stably and indeed fixed on the side cover plate. Furthermore, by that the base seat and the side cover plate are provided therebetween with the third assembling construction which allows the base seat and the side cover plate to cooperate with each other, strength and stability of unitary assembling of the light guide member can be further increased. Moreover, by that the light guide member and the side cover plate therebetween include the inserting construction and the clipping construction, the light guide member is capable of being more firmly fixed, and the light guide member is further capable of being detached. Moreover, by that the light guide member and the side cover plate therebetween include the interference cooperating construction and the elastic latching construction, the light guide member is capable of being more firmly fixed, and the light guide member is further capable of being detached. Moreover, by that in a process that the retaining piece inserts into the retaining hole, the front protruding portion firstly interferes with and scratches the internal protruding portion, although the internal protruding portion is partially scratched but still substantially maintains as a protruding block to pass over the front protruding portion and then enters into the recessed portion, in turn is limited by the front protruding portion and the rear protruding portion, conversely, when the retaining piece withdraws from the retaining hole, the internal protruding portion will scratch the front protruding portion again and still maintains as a protruding block to pass over the front protruding portion, in this way, it is beneficial for the retaining hole to be capable of being assembled and used again. On the other hand, the light guide member is provided to the outer side of the corresponding side wall, a sideward space is saved, at the same time the light guide member is capable of being assembled and detached in the up-down direction or in the assembling direction that the light guide member faces the side cover plate, particularly in a combination that a plurality of connector assemblies are arranged side by side, a plurality of the guiding shield cages are capable of being compactly arranged.

### BRIEF DESCRIPTION OF THE DRAWINGS

Other features and effects of the present disclosure will be apparent from embodiments with reference to the drawings, in which:

FIG. 1 is a perspective view of an embodiment of a connector assembly of the present disclosure and a pluggable module;

FIG. 2 is another perspective view of the embodiment;

FIG. 3 is a perspective exploded view of the embodiment of FIG. 2;

FIG. 4 is a perspective view of a guiding shield cage and a side cover plate of the embodiment;

FIG. 5 is a perspective view of the side cover plate of the embodiment;

FIG. 6 is a perspective exploded view of the side cover plate, a base seat and a light guide member of the embodiment;

FIG. 7 is a partially cut-away perspective view of the side cover plate, the base seat and the light guide member of the embodiment;

FIG. 8 is a perspective view of the side cover plate, the base seat and the light guide member of the embodiment;

FIG. 9 is an enlarged partially cut-away perspective view of a region A of FIG. 7;

FIG. 10 is a perspective exploded view of the base seat and the light guide member of the embodiment;

FIG. 11 is a perspective view of a second embodiment of a connector assembly of the present disclosure;

FIG. 12 is a perspective exploded view of the second embodiment of FIG. 11, and a plurality of grounding members, a receptacle connector and an external heat sink of the second embodiment are removed;

FIG. 13 is a partial perspective view of the second embodiment illustrating a side cover plate assembled on a guiding shield cage and constructions of a plurality of retaining pieces and a latch piece;

FIG. 14 is a partially cut-away enlarged perspective view illustrating a connecting relationship among a base seat, a light guide member and a first assembling construction and the side cover plate in the second embodiment;

FIG. 15 is a perspective exploded view illustrating implementing details of the base seat, the light guide member, the first assembling construction and the side cover plate;

FIG. 16 is an incomplete cross sectional view taken along a line XVI-XVI of FIG. 14;

FIG. 17 is a side view of the corresponding FIG. 14;

FIG. 18 is an incomplete cross sectional view taken along a XVIII-XVIII of FIG. 17; and

FIG. 19 is an incomplete cross sectional view taken along a XIX-XIX of FIG. 17.

### REFERENCE NUMERALS ARE PRESENTED AS FOLLOWS

100, 100′ connector assembly
1 guiding shield cage
11 cage
111 top wall
111a upper window
112 bottom wall
113 side wall
113a assembling hole
113b heat dissipating hole
113c guiding rail
113d positioning elastic piece
113e elastic piece opening
113f inward extending elastic piece
113g latching protrusion
114 rear wall
115 inserting leg
12 partitioning frame
121 upper wall
122 lower wall
122a lower window
123 front wall
124 side connecting wall
125 internal receiving space
126 assembling piece
13 movable frame
131 guiding piece
14 grounding member
141 elastic portion
15 upper receiving space
151 upper inserting port
16 lower receiving space
161 lower inserting port
2 receptacle connector
21 housing
211 upper slot
212 lower slot
22 terminal
221 contact portion
222 tail portion
3 internal heat sink
31 internal heat dissipating member
311 internal heat dissipating base plate
312 internal heat dissipating fin
313 internal thermal coupling portion
32 internal pressure applying spring
321 pressing plate
322 plate-shaped spring piece
4 external heat sink
41 external heat dissipating member
411 external heat dissipating base plate
412 external heat dissipating fin
413 external thermal coupling portion
414 accommodating recessed groove
42 elastic clip
421 elastic pressing portion
422 assembling portion
422a latching hole
5 covering plate
51 assembling hole
6 side cover plate
60 sideward protruding piece
61 assembling hole
62 first opening
63 second opening
641 retaining portion
641a interfering protrusion
651 inserting rod receiving groove
652 positioning recess
653 position-limiting groove
66 U-shaped protrusion
67 bulge
68 position-limiting piece
7, 7′ base seat
71 light guiding pipe receiving hole
721 retaining groove
731, 731′ latching groove
731a, 731a′ latching hook cooperating portion
8, 8′ light guide member
80 supporting portion
81 light guiding pipe
811 forward extending segment
812 downward extending segment
813 bending segment
814 light inputting end
815 light outputting end
82, 82′ connecting rod
83 supporting rod
831 inserting rod
832 positioning block
833 position-limiting block
834 supporting blocks
841, 841′ latching block
841a, 841a′ latching hook
9a, 9a′ first assembling construction
9b, 9b′ second assembling construction
9c third assembling construction
91 inserting construction
92 clipping construction
93 interference cooperating construction
931 retaining hole
932 retaining piece
933 internal protruding portion
934 front protruding portion
935 recessed portion
936 rear protruding portion
94 elastic latching construction
941 latch block
942 latch piece
943 guiding surface
944 latch hole
945 guiding edge
200 pluggable module
201 shell member
201a inserting portion
201b locking recessed groove
202 mating circuit board
203 cable
204 locking release member
D1 front-rear direction
D2 up-down direction
D3 left-right direction

### DETAILED DESCRIPTION

Before the present disclosure is described in detail, it is noted that the similar elements are indicated by the same reference numerals in the following description.

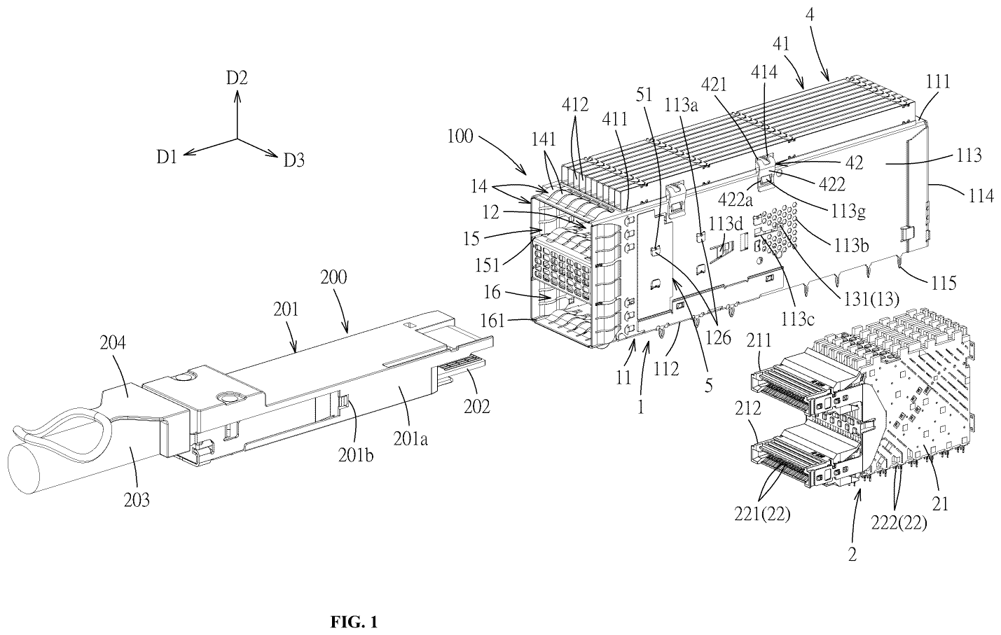

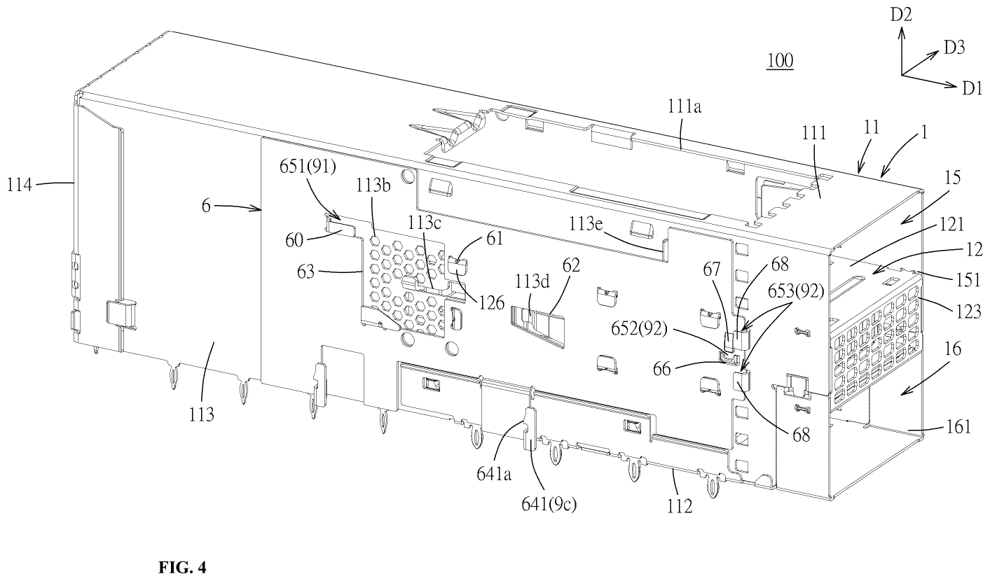

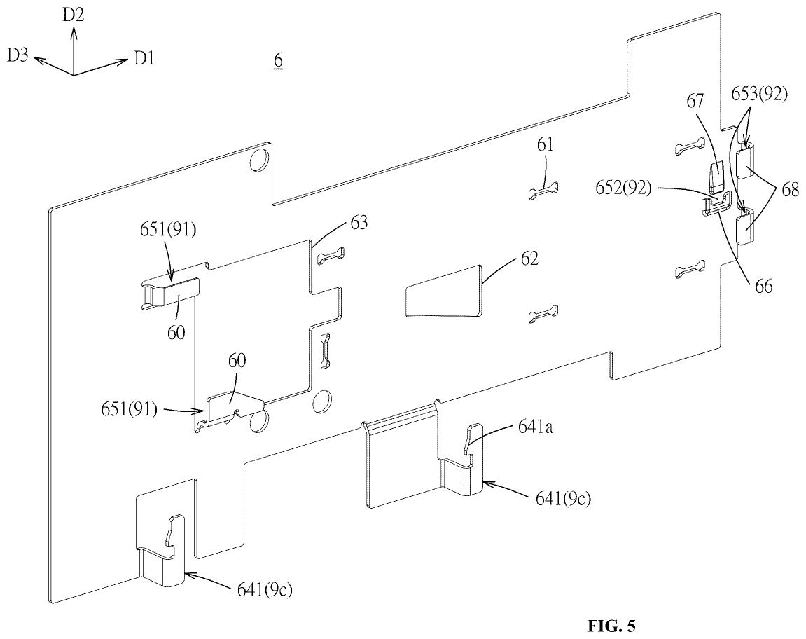

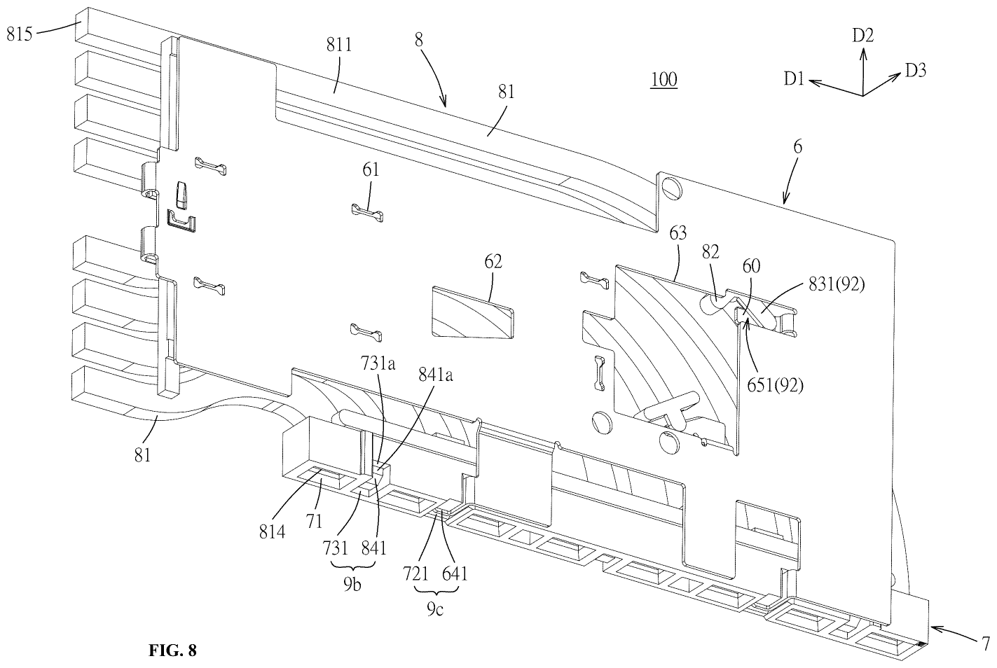

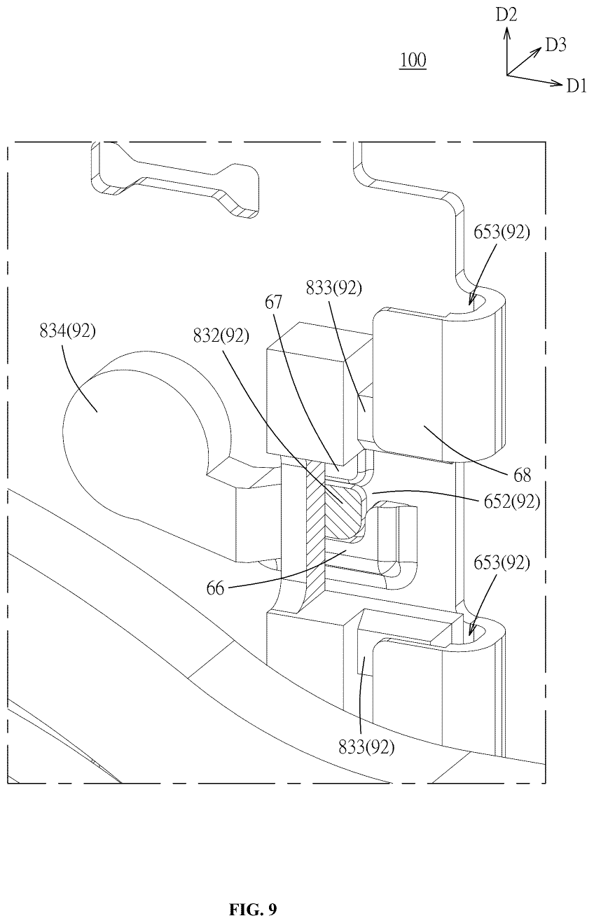

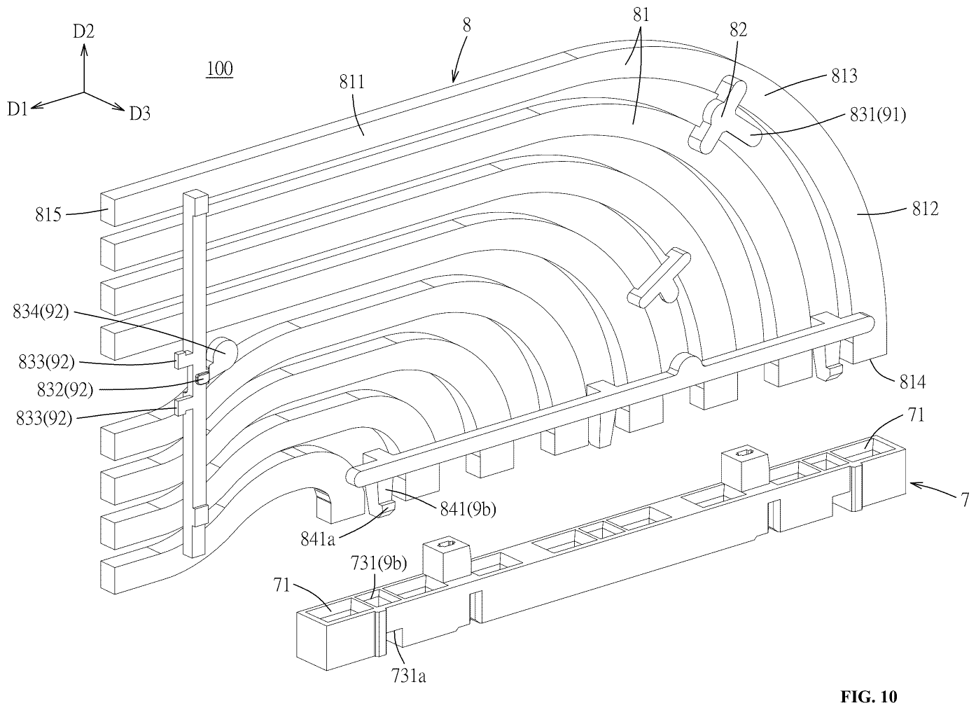

Referring to FIG. 1 to FIG. 10, a first embodiment of a connector assembly 100 of the present disclosure is illustrated. As shown in FIG. 1 to FIG. 3, the connector assembly 100 is adapted to be provided to a circuit board (not shown) and is adapted to mate with a pluggable module 200. The connector assembly 100 includes a guiding shield cage 1, a receptacle connector 2, an internal heat sink 3, an external heat sink 4, a covering plate 5, a side cover plate 6, a base seat 7, a light guide member 8, a first assembling construction 9a, a second assembling construction 9b and a third assembling construction 9c.

The guiding shield cage 1 is for example formed by processing, such as stamping and bending, a metal thin plate, the guiding shield cage 1 is used to be provided to the circuit board, the guiding shield cage 1 includes a cage 11, a partitioning frame 12, a movable frame 13, and a plurality of grounding members 14. The cage 11 extends along a front-rear direction D1 (a direction to which an arrow points is front, and an opposite direction is rear), and has a top wall 111 and a bottom wall 112 which face each other in an up-down direction D2 (a direction to which an arrow points is up, and an opposite direction is down), two side walls 113 which are spaced apart from each other along a left-right direction D3 (a direction to which an arrow points is right, and an opposite direction is left), and a rear wall 114 which is positioned to a rear end of the cage 11 along the front-rear direction D1. Lower edges of the two side walls 113 and a lower edge of the rear wall 114 are constructed with a plurality of inserting legs 115 which extend downwardly and are adapted to be fixed on the circuit board and/or be connected to grounding traces (not shown).

The partitioning frame 12 is provided in the cage 11, the partitioning frame 12 and the cage 11 together define an upper receiving space 15 and a lower receiving space 16, a rear segment of the upper receiving space 15 and a rear segment of the lower receiving space 16 are communicated with each other. The upper receiving space 15 has an upper inserting port 151 which is positioned in the front of the upper receiving space 15 and allows the pluggable module 200 to insert therein, the lower receiving space 16 has a lower inserting port 161 which is positioned in the front of the lower receiving space 16 and allows the pluggable module 200 to insert therein, and a bottom opening (not shown) which is positioned at a rear of a bottom portion of the lower receiving space 16. In the first embodiment, the partitioning frame 12 has an upper wall 121 and a lower wall 122 which face each other up and down, a front wall 123 which are connected to a front edge of the upper wall 121 and a front edge of the lower wall 122, and two side connecting walls 124 which are connected to a rear segment of a side edge of the upper wall 121 and a rear segment of a side edge of the lower wall 122, the upper wall 121, the lower wall 122, the front wall 123 and the two side connecting walls 124 together define an internal receiving space 125. Each side wall 113 of the cage 11 has a plurality of assembling holes 113a and a plurality of heat dissipating holes 113b which are penetratingly formed. The partitioning frame 12 further has a plurality of assembling pieces 126 which extend to outer sides of the two side walls 113, the plurality of the assembling piece 126 respectively pass through the assembling holes 113a of the two side walls 113 and then are bent and fixed, so that the partitioning frame 12 is stably assembled to the cage 11.

The movable frame 13 is provided to a rear segment of the partitioning frame 12 and is slidable along the front-rear direction D1, the movable frame 13 has two guiding pieces 131 which protrude outwardly from side surfaces of the movable frame 13 respectively. Each side wall 113 of the cage 11 further has a guiding rail 113c which receives and guides the corresponding guiding piece 131, and a positioning elastic piece 113d which has a tip thereof to be recessed inwardly and is used to position the movable frame 13.

The cage 11 and the partitioning frame 12 are assembled with the plurality of grounding members 14 which are positioned at a front end of the cage 11 and a front end of the partitioning frame 12. In the first embodiment, the connector assembly 100 may be provided to a mounting hole (not shown) of a casing (not shown), each grounding member 14 has a plurality of elastic portions 141 which extend rearwardly and are distributed to an outer side and an inner side of the cage 11, the clastic portion 141 of the plurality of elastic portions 141 which is positioned to the outer side of the cage 11 is used to contact the mounting hole of the casing, the elastic portion 141 of the plurality of elastic portions 141 which is positioned to the inner side of the cage 11 is used to contact the pluggable module 200.

The receptacle connector 2 is provided on the circuit board and is received in a rear segment of the guiding shield cage 1 (that is, the rear segment of the upper receiving space 15 and the rear segment of the lower receiving space 16 which are communicated with each other) from down to up via the bottom opening. The receptacle connector 2 has a housing 21 which is insulative, and a plurality of terminals 22 which are provided to the housing 21, the housing 21 has an upper slot 211 and a lower slot 212 which are toward the front and are arranged along the up-down direction D2, the upper slot 211 and the lower slot 212 respectively correspond to the upper receiving space 15 and the lower receiving space 16. Each terminal 22 has a contact portion 221 which is positioned in the upper slot 211 or the lower slot 212, and a tail portion 222 which extends downwardly out of a bottom portion of the housing 21 and is used to be mechanically and electrically connected to the circuit board.

The pluggable module 200 has a shell member 201, a mating circuit board 202, and a cable 203. The shell member 201 has an inserting portion 201a which is used to insert into the upper receiving space 15 or the lower receiving space 16. The mating circuit board 202 is provided to the inserting portion 201a, protrudes from the inserting portion 201a, and is used to insert into the upper slot 211 or the lower slot 212. The cable 203 is provided to the shell member 201 and is electrically connected to the mating circuit board 202. Each side wall 113 of the cage 11 further has two elastic piece openings 113e which respectively correspond to the upper receiving space 15 and the lower receiving space 16, and two inward extending elastic pieces 113f which are constructed to the two clastic piece openings 113e respectively and obliquely extend toward an interior of the guiding shield cage 1 and toward the rear of the guiding shield cage 1. A left side and a right side of the inserting portion 201a of the pluggable module 200 are respectively provided with two locking recessed grooves 201b which correspondingly cooperate with the two inward extending elastic pieces 113f, so as to generate a locking effect. In addition, the pluggable module 200 further has a locking release member 204, when the locking release member 204 is pulled, the inward extending elastic piece 113f can be pushed out of the locking recessed groove 201b.

The internal heat sink 3 is provided to the internal receiving space 125 of the partitioning frame 12 and has an internal heat dissipating member 31, and an internal pressure applying spring 32 which is provided between the internal heat dissipating member 31 and the upper wall 121 of the partitioning frame 12. The internal heat dissipating member 31 has an internal heat dissipating base plate 311, a plurality of internal heat dissipating fins 312 which are arranged side by side along left-right direction D3, latch with each other and are provided to a top surface of the internal heat dissipating base plate 311, and an internal thermal coupling portion 313 which is provided to a bottom surface of the internal heat dissipating base plate 311 and enters into the lower receiving space 16 via a lower window 122a of the lower wall 122 of the partitioning frame 12. The internal pressure applying spring 32 has a pressing plate 321 which presses against a top portion of the internal heat dissipating member 31, and a plurality of plate-shaped spring pieces 322 which extend out from the pressing plate 321 and push against the upper wall 121 of the partitioning frame 12. When the pluggable module 200 inserts into the lower receiving space 16, the pluggable module 200 can raise the internal heat dissipating member 31, so that the pluggable module 200 contacts the internal thermal coupling portion 313, at the same time the internal heat dissipating member 31 which is raised makes the internal pressure applying spring 32 compressed to provide an elastic acting force. With the clastic acting force applied to the internal heat dissipating member 31 by the internal pressure applying spring 32, the internal heat dissipating member 31 is capable of being moved along the up-down direction D2 relative to the partitioning frame 12, and the internal thermal coupling portion 313 of the internal heat dissipating member 31 contacts the pluggable module 200 under that the internal thermal coupling portion 313 of the internal heat dissipating member 31 is applied with the elastic acting force, so as to assure contact completeness and enhance heat dissipating performance.

The external heat sink 4 includes an external heat dissipating member 41 and two elastic clips 42. The external heat dissipating member 41 is provided at an upper window 111a of the top wall 111 of the cage 11 of the guiding shield cage 1, the external heat dissipating member 41 has an external heat dissipating base plate 411 which is provided to the top wall 111, a plurality of external heat dissipating fins 412 which are arranged side by side along left-right direction D3, latch with each other and are provided to a top surface of the external heat dissipating base plate 411, and an external thermal coupling portion 413 which is provided to a bottom surface of the external heat dissipating base plate 411 and enters into the upper receiving space 15 via the upper window 111a. The external heat dissipating member 41 is assembled to the top wall 111 of the guiding shield cage 1 by means of the two elastic clips 42, so that the external heat dissipating member 41 is elastically movable relative to the upper receiving space 15 and the external thermal coupling portion 413 of the external heat dissipating member 41 elastically contacts the pluggable module 200 which inserts into the upper receiving space 15. Each elastic clip 42 has an elastic pressing portion 421 which extends along the left-right direction D3 and presses against the external heat dissipating base plate 411 of the external heat dissipating member 41 from above, and two assembling portions 422 which extend downwardly from two ends of elastic pressing portion 421 respectively and respectively latch to the two side walls 113 of the guiding shield cage 1, specifically, each side wall 113 is formed with two latching protrusions 113g, each assembling portion 422 is formed with a latching hole 422a which correspondingly latches with the latching protrusion 113g of the corresponding side wall 113. In addition, the external heat dissipating member 41 further has two accommodating recessed grooves 414 which are formed on the plurality of external heat dissipating fins 412 and are used to accommodate the elastic pressing portions 421 of the two elastic clips 42 respectively, so that the two elastic clips 42 are engaged on the external heat dissipating member 41 to constitute the external heat sink 4 which is unitary.

The covering plate 5 is a metal plate. The covering plate 5 is assembled on one of the two side walls 113 of the cage 11 of the guiding shield cage 1. In the first embodiment, the covering plate 5 is assembled to the side wall 113 which is on the right and covers two elastic piece openings 113c and some existing opened holes of the side wall 113 which is on the right, so as to increase an electromagnetic interference (EMI) suppressing effect. The covering plate 5 has a plurality of assembling holes 51 which correspond to the plurality of assembling holes 113a of the corresponding side wall 113, the corresponding assembling pieces 126 of the partitioning frame 12 respectively outwardly and sequentially pass through the plurality of the assembling holes 113a of the corresponding side wall 113 and the plurality of assembling hole 51 of the covering plate 5 and then are bent and fixed, and latch to the covering plate 5, so that the covering plate 5 is stably assembled to the cage 11.

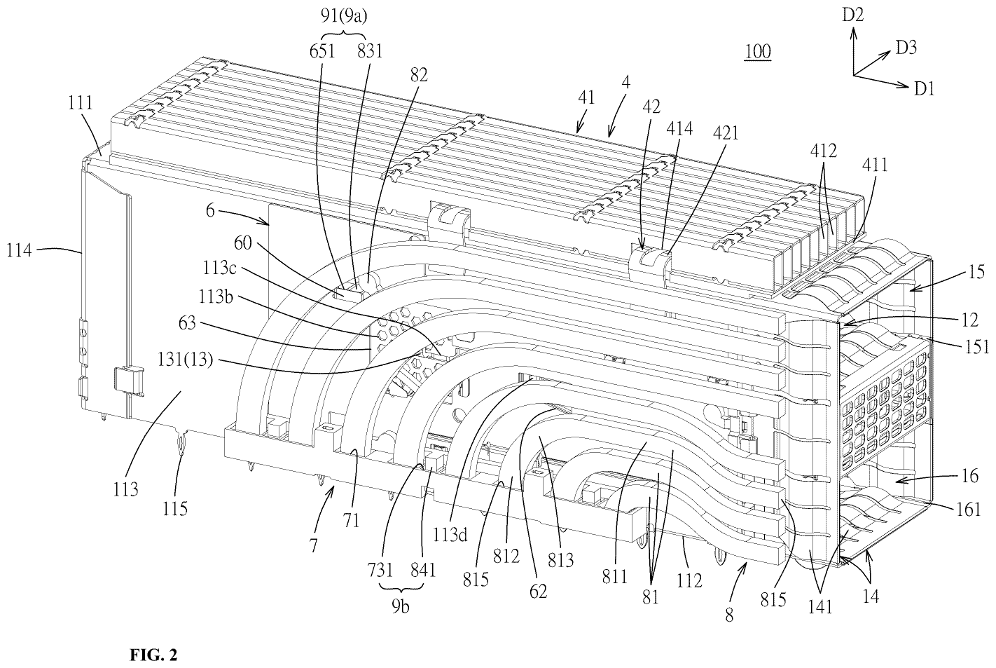

Referring to FIG. 2 to FIG. 5, the side cover plate 6 is a metal plate. The side cover plate 6 is assembled to an outer side of the other of the two side walls 113 of the cage 11 of the guiding shield cage 1. In the first embodiment, the side cover plate 6 is assembled on the side wall 113 which is on the left and covers the two elastic piece openings 113e and some existing opened holes of the side wall 113 on the left, so as to increase electromagnetic interference (EMI) suppressing effect. The side cover plate 6 has a plurality of assembling holes 61 which correspond to the plurality of assembling holes 113a of the corresponding side wall 113, the corresponding assembling pieces 126 of the partitioning frame 12 respectively outwardly and sequentially pass through the plurality of assembling holes 113a of the corresponding side wall 113 and the plurality of assembling holes 61 of the side cover plate 6 and then are bent and fixed, and latch to the side cover plate 6, so that the side cover plate 6 is stably assembled to the cage 11. The side cover plate 6 has a first opening 62 which is used to avoid the positioning elastic piece 113d of the corresponding side wall 113, and a second opening 63 which is used to avoid the guiding piece 131 of the movable frame 13 extending out of the guiding rail 113c of the side wall 113 and the plurality of heat dissipating holes 113b of the corresponding side wall 113.

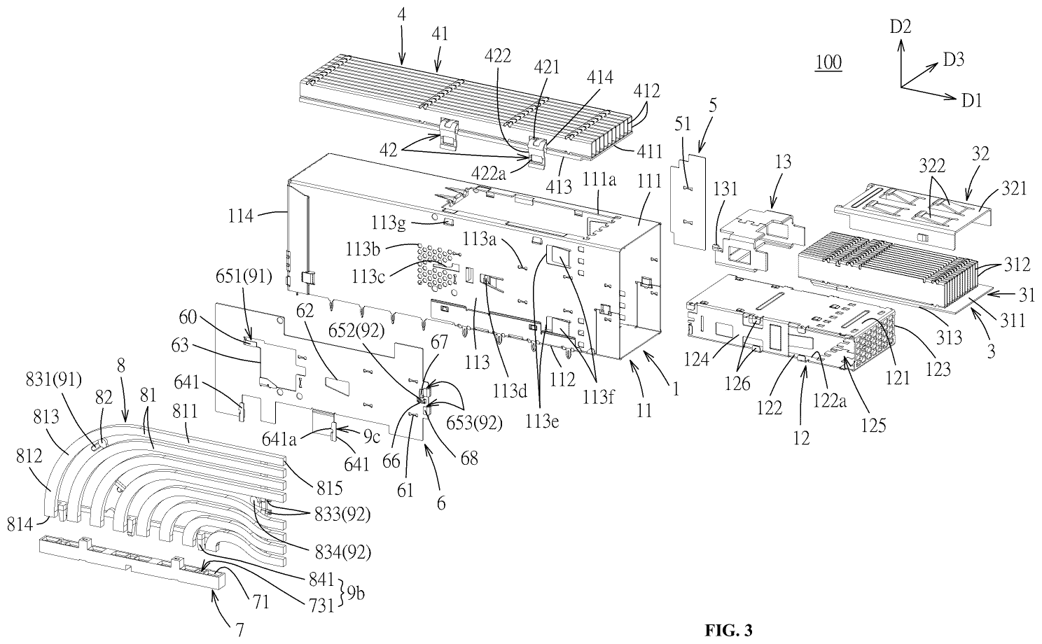

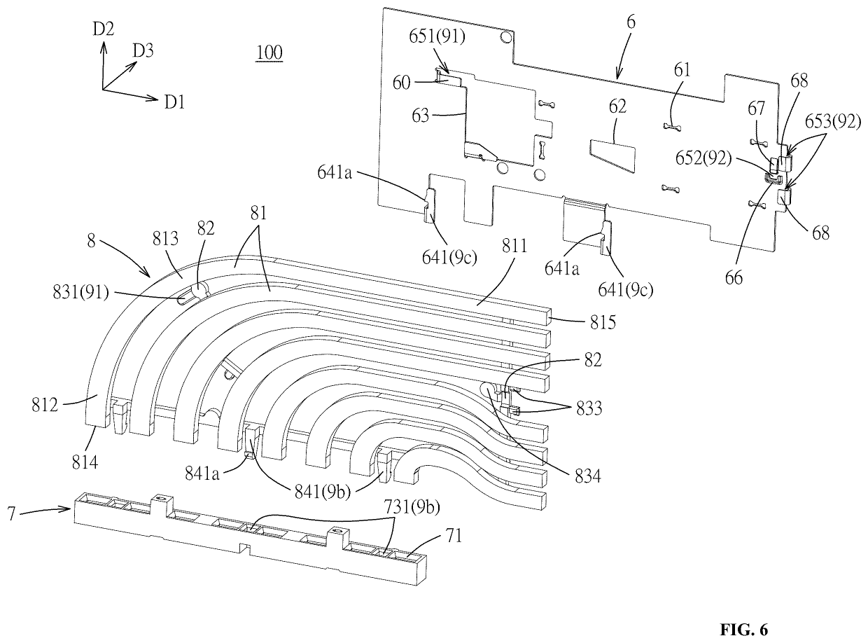

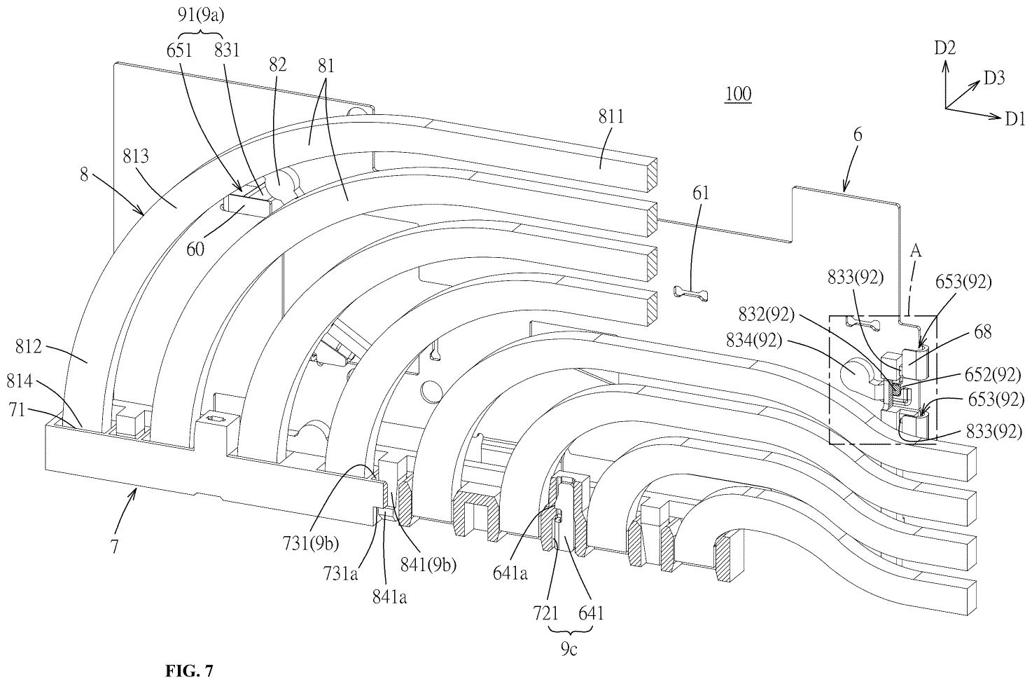

Referring to FIG. 2, FIG. 3, FIG. 6 and FIG. 7, the base seat 7 preferably has a light-shading construction and function, the base seat 7 may be formed by injection molding a material, which for example has a color, with a mold, or for example after the base seat 7 is formed, a light-shading material is added on the base seat 7 by a process, such as painting, plating, adhering, molding and the like. The base seat 7 has a plurality of light guiding pipe receiving holes 71 which are penetratingly formed up and down. The base seat 7 is assembled to an outer side of the side cover plate 6.

Referring to FIG. 6 to FIG. 10, the light guide member 8 has a plurality of light guiding pipes 81, and a plurality of connecting rods 82 which are connected between the plurality of light guiding pipes 81, the plurality of light guiding pipes 81 are sequentially arranged from up to down in a plane which is substantially parallel to the corresponding side wall 113 of the cage 11 and are spaced apart from each other. Each light guiding pipe 81 has a forward extending segment 811 which is positioned in the front of the light guiding pipe 81 and extends forwardly, a downward extending segment 812 which is positioned at the rear of the light guiding pipe 81 and extends downwardly, a bending segment 813 which is positioned between the forward extending segment 811 and the downward extending segment 812, a light inputting end 814 which is positioned to a tip of the downward extending segment 812, and a light outputting end 815 which is positioned to a tip of the forward extending segment 811. The plurality of light guiding pipes 81 are therebetween connected with each other respectively by the plurality of connecting rods 82, the plurality of connecting rods 82 for example may be distributed and provided between the forward extending segments 811, the bending segments 813 and the downward extending segments 812 of the plurality of light guiding pipes 81.

The light guide member 8 is assembled on the side cover plate 6 and the base seat 7, and the light inputting ends 814 of the plurality of light guiding pipes 81 are respectively received in the plurality of light guiding pipe receiving holes 71 of the base seat 7. Spaces respectively between bottom portions of the plurality of light guiding pipe receiving holes 71 and the light inputting ends 814 of the plurality of light guiding pipes 81 are used to respectively accommodate light emitting members (not shown) on the circuit board.

The first assembling construction 9a is provided between the light guide member 8 and the side cover plate 6, and is used to assemble the light guide member 8 on the side cover plate 6. The first assembling construction 9a has an inserting construction 91 and a clipping construction 92. The inserting construction 91 includes two inserting rods 831 which are provided on the two corresponding connecting rods 82 of the light guide member 8, and two inserting rod receiving grooves 651 which are formed to the side cover plate 6 and receive the two inserting rods 831 respectively. The inserting rod 831 is assembled into the inserting rod receiving groove 651 in a direction which is toward the down.

The clipping construction 92 of the first assembling construction 9a has a positioning block 832, two position-limiting blocks 833 and a supporting block 834 which are provided on one, which is close to the light outputting ends 815 of the light guide member 8, of the plurality of connecting rods 82, and a positioning recess 652 and two position-limiting grooves 653 which are provided on the side cover plate 6.

The positioning block 832 protrudes toward the side cover plate 6, the two position-limiting blocks 833 are respectively provided above and below the positioning block 832 and extend toward the front. The supporting block 834 extends rearwardly and slightly inwardly. The side cover plate 6 is integrally constructed with two sideward protruding pieces 60 which extend outwardly, a U-shaped protrusion 66 which is opened upwardly, and a bulge 67 which is positioned above the U-shaped protrusion 66, the two sideward protruding pieces 60 and a body of the side cover plate 6 therebetween constitute the two inserting rod receiving grooves 651, the U-shaped protrusion 66 and the bulge 67 therebetween constitute the positioning recess 652. The side cover plate 6 integrally includes two position-limiting pieces 68 which are folded back and extend outwardly and rearwardly, the two position-limiting pieces 68 and the body of the side cover plate 6 therebetween constitute the two position-limiting grooves 653. The positioning block 832 is received in the positioning recess 652. The two position-limiting blocks 833 respectively insert into the two position-limiting grooves 653 from up to down. The supporting block 834 is supported on the side cover plate 6.

The second assembling construction 9b is provided between the light guide member 8 and the base seat 7. The second assembling construction 9b includes a plurality of latching blocks 841 provided on the connecting rods 82 of the light guide member 8 which are close to the light inputting ends 814, and a plurality of latching grooves 731 which is provided on the base seat 7 and are used to latch with the plurality of latching blocks 841 respectively. Each latching block 841 extends downwardly and has a latching hook 841a which is positioned to a tip of the latching block 841. Each latching groove 731 is provided therein with a latching hook cooperating portion 731a which cooperates with the corresponding latching hook 841a. The latching block 841 is assembled into the latching groove 731 in a direction which is toward the down.

The third assembling construction 9c is provided between the base seat 7 and the side cover plate 6. The third assembling construction 9c includes a plurality of retaining grooves 721 which are provided to the base seat 7, and a plurality of retaining portions 641 which are provided to the side cover plate 6 and insert into the plurality of retaining grooves 721 respectively. Openings of the plurality of retaining grooves 721 are positioned to a bottom surface of the base seat 7 and the plurality of retaining grooves 721 extend upwardly from the openings respectively. The plurality of retaining portions 641 are integrally formed from cutting the side cover plate 6, upwardly extend to an outer side of the body of the side cover plate 6, and each retaining portion 641 has an interfering protrusion 641a which cooperates with corresponding the retaining groove 721 by interference. The retaining groove 721 is assembled onto the retaining portion 641 in a direction which is toward the down.

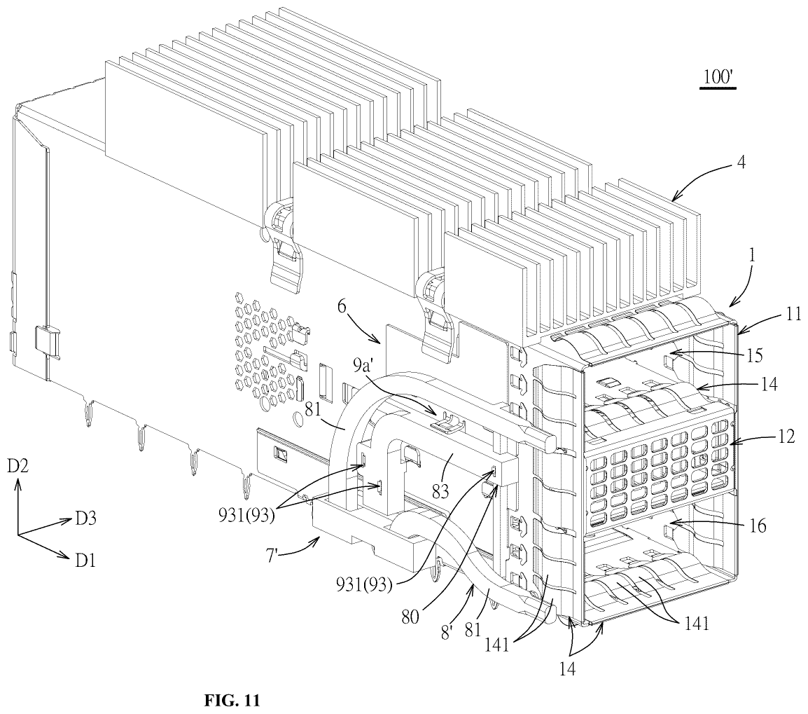

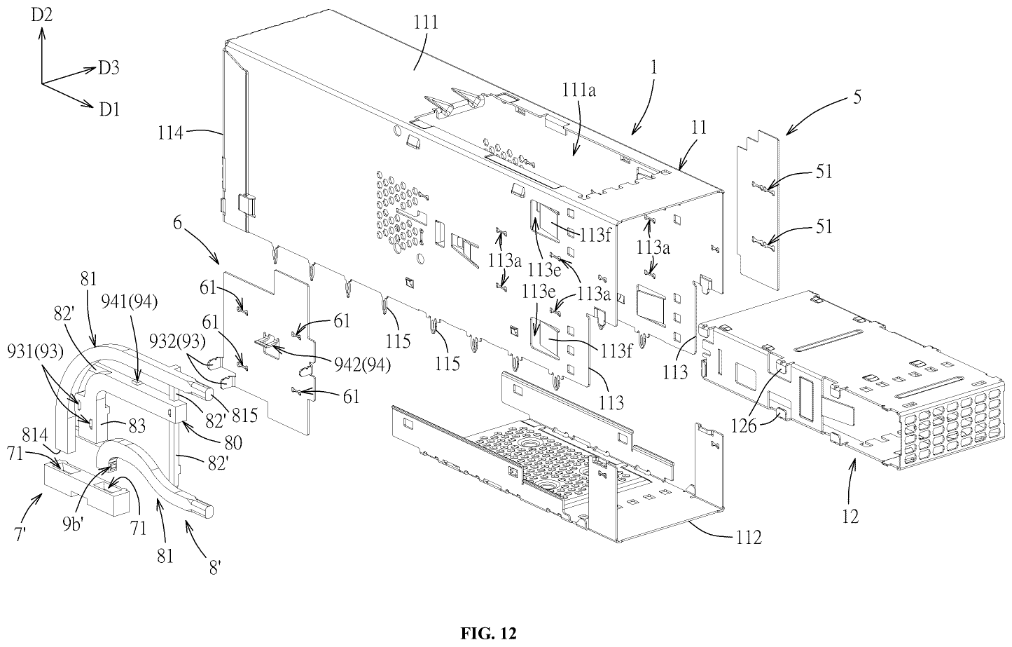

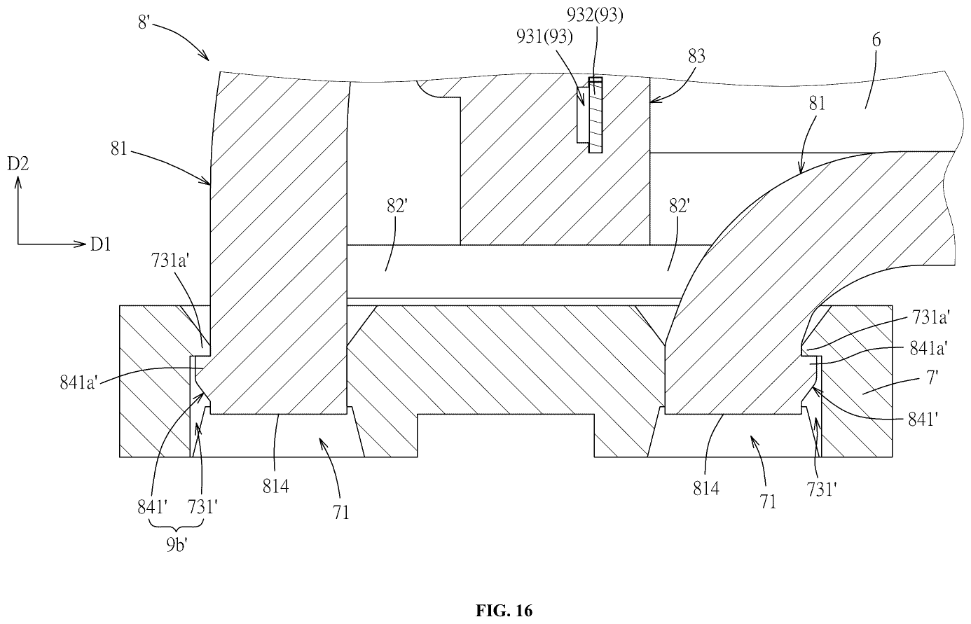

Referring to FIG. 11 to FIG. 19, a second embodiment of a connector assembly 100′ of the present disclosure is illustrated. As shown in FIG. 11 and FIG. 12, the second embodiment is close to the first embodiment in structure, the second embodiment is similarly adapted to be provided to a circuit board (not shown), and is capable of allowing the pluggable module 200 to mate therewith. And the second embodiment similarly includes a guiding shield cage 1, a receptacle connector 2 (see FIG. 1), an internal heat sink (not shown), an external heat sink 4, a covering plate 5, a side cover plate 6, a base seat 7′, a light guide member 8′, a first assembling construction 9a′ and a second assembling construction 9b′.

Referring to FIG. 11 to FIG. 13, specifically, the side cover plate 6 similarly is detachably assembled to an outer side of one of the two side walls 113 of the guiding shield cage 1. In the second embodiment, the side cover plate 6 is assembled on the side wall 113 which is on the left and covers two elastic piece openings 113e and some existing opened holes of the side wall 113 which is on the left, so as to increase electromagnetic interference (EMI) suppressing effect.

Referring to FIG. 11 and FIG. 12, similarly, the base seat 7′ is positioned to an outer side of the side cover plate 6 (an inner side of the side cover plate 6 is one side which faces the guiding shield cage 1, the outer side of the side cover plate 6 is the other side which is opposite to the guiding shield cage 1), and extends along the front-rear direction D1. The base seat 7′ includes a plurality of light guiding pipe receiving holes 71 which are formed to a top surface of the base seat 7′, penetrate downwardly to a bottom surface of the base seat 7′, and allow the light guide member 8′ to insert therein. Similarly, the light guide member 8′ is assembled on the outer side of the side cover plate 6 and the base seat 7′, and has a plurality of light guiding pipes 81. And similarly, each light guiding pipe 81 has a forward extending segment 811 which is positioned in the front of the light guiding pipe 81 and extends forwardly, a downward extending segment 812 which is positioned at the rear of the light guiding pipe 81 and extends downwardly, a bending segment 813 which is positioned between the forward extending segment 811 and the downward extending segment 812, a light inputting end 814 which is positioned to a tip of the downward extending segment 812, and a light outputting end 815 which is positioned to a tip of the forward extending segment 811.

However, one of differences between the second embodiment and the first embodiment lies in that, the third assembling construction 9c of the first embodiment (see FIG. 7) may be removed in the second embodiment. In the second embodiment, the number of the light guiding pipe receiving holes 71 and the number of the light guiding pipes 81 each take two as example. And the two forward extending segments 811 are arranged in the up-down direction D2 and are spaced apart from each other, the two downward extending segments 812 are arranged in the front-rear direction D1 and are spaced apart from each other. The light inputting ends 814 of the two light guiding pipes 81 are respectively received in the two light guiding pipe receiving holes 71 of the base seat 7′. Moreover, the light guide member 8′ further has a supporting portion 80 which is integrally connected to the two light guiding pipes 81. The supporting portion 80 includes a supporting rod 83 which positioned between the two adjacent light guiding pipes 81 and a plurality of connecting rods 82′ which are connected to the two light guiding pipes 81. The supporting rod 83 curvedly extends from a side which is adjacent to the light outputting ends 815 toward the rear (toward a direction close to the bending segments 813) and toward the down (toward a direction close to the light inputting ends 814) along an extending direction of the two light guiding pipes 81 to slightly be L-shaped.

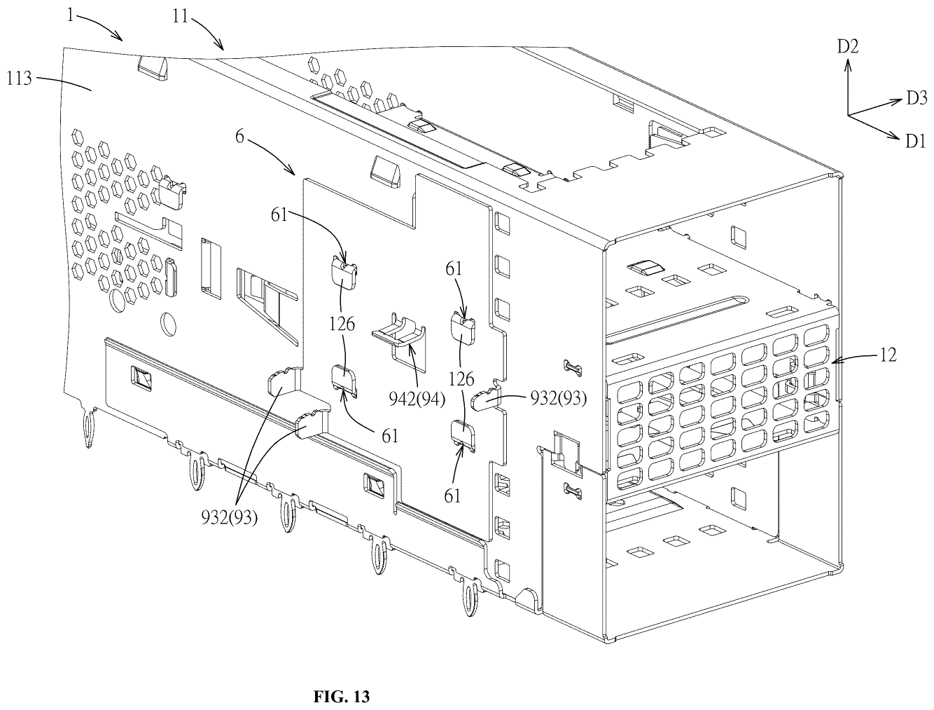

Moreover, referring to FIG. 13 to FIG. 16, the second assembling construction 9b′ is provided between the light guide member 8′ and the base seat 7′. Specifically, the second assembling construction 9b′ includes a plurality of latching blocks 841′ (here two latching blocks 841′ as example) which are respectively provided at the light inputting ends 814 of the plurality of light guiding pipes 81, and a plurality of latching grooves 731′ (here two latching grooves 731′ as example) which are respectively formed to inner walls of the plurality of light guiding pipe receiving holes 71 of the base seat 7′. The plurality of latching blocks 841′ respectively latch with the plurality of the latching grooves 731′. Each latching block 841′ protrudes transversely from the corresponding light inputting end 814 to form a latching hook 841a′. A top side of the inner wall of each latching groove 731′ is provided with a latching hook cooperating portion 731a′ which cooperates with the latching hook 841a′. That is to say, in the second embodiment, the plurality of latching grooves 731′ are respectively formed to the inner walls of the plurality of light guiding pipe receiving holes 71 of the base seat 7′; the plurality of latching blocks 841′ are provided to the plurality of light inputting ends 814 of the light guide member 8′, so that the light guide member 8′ of the second embodiment still is capable of respectively limiting the plurality of latching hooks 841a′ by the plurality of latching hook cooperating portions 731a′, thus the latching block 841′ cannot be separated from the latching groove 731′ without acting of an external force, so as to increase a retention force which retains the light guide member 8′ to the base seat 7′.

Preferably, in the second embodiment, a material of the base seat 7′ is a soft material containing a rubber, which is beneficial to assembling of the base seat 7′ and the light guide member 8′, and it also is easier to detach the base seat 7′ and the light guide member 8′. Moreover, the base seat 7′ is not transparent, and has a light-shading effect.

Referring to FIG. 13 to FIG. 15, the first assembling construction 9a′ is provided between the light guide member 8′ and the side cover plate 6, and is used to assemble the light guide member 8′ on the side cover plate 6. Another difference between the second embodiment and the first embodiment lies in that, the inserting construction 91 (see FIG. 7) and the clipping construction 92 (see FIG. 7) of the first embodiment may be removed. And the first assembling construction 9a′ of the second embodiment includes an interference cooperating construction 93 and an elastic latching construction 94. The interference cooperating construction 93 has a plurality of retaining holes 931 (here three retaining holes 931 as example) which are formed to the light guide member 8′, and a plurality of retaining pieces 932 (here three retaining pieces 932 as example) which are provided to the side cover plate 6. Specifically, the plurality of retaining holes 931 penetrate an inner side and an outer side of the supporting rod 83 (the inner side of the supporting rod 83 is a side which faces the side cover plate 6, the outer side of the supporting rod 83 is the other side which is opposite to the side cover plate 6), and are respectively positioned to of a front segment and a rear segment of the supporting rod 83. The retaining piece 932 is in form of thin piece shape, and extends from a side edge of the side cover plate 6 along the left-right direction D3 toward a direction which is away from the guiding shield cage 1 or extends toward the light guide member 8′, and positions of the plurality of retaining pieces 932 respectively correspond to the plurality of retaining holes 931. The retaining piece 932 may be formed by integrally cutting the edge of the side cover plate 6 and then bending outwardly, but the present disclosure is not limited thereto.

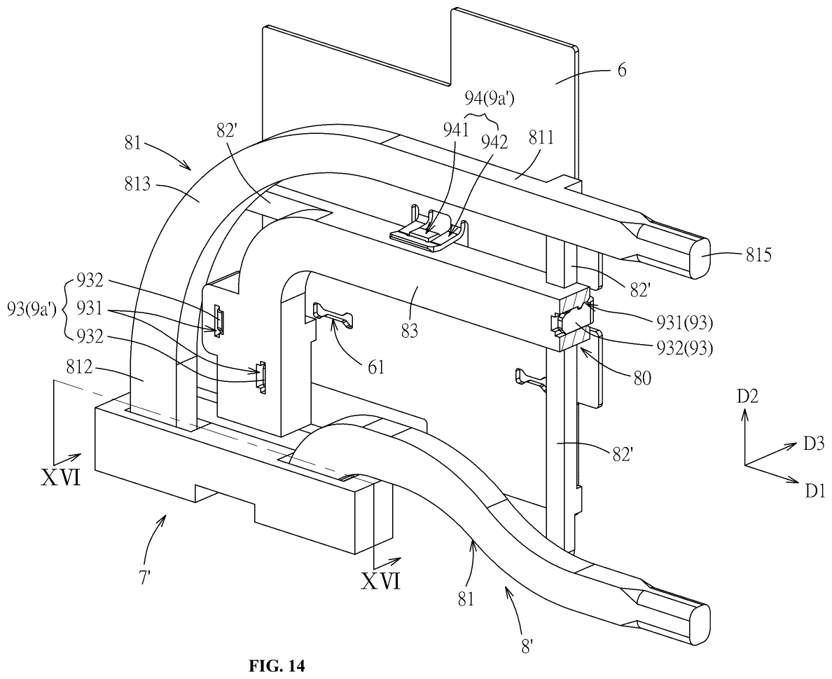

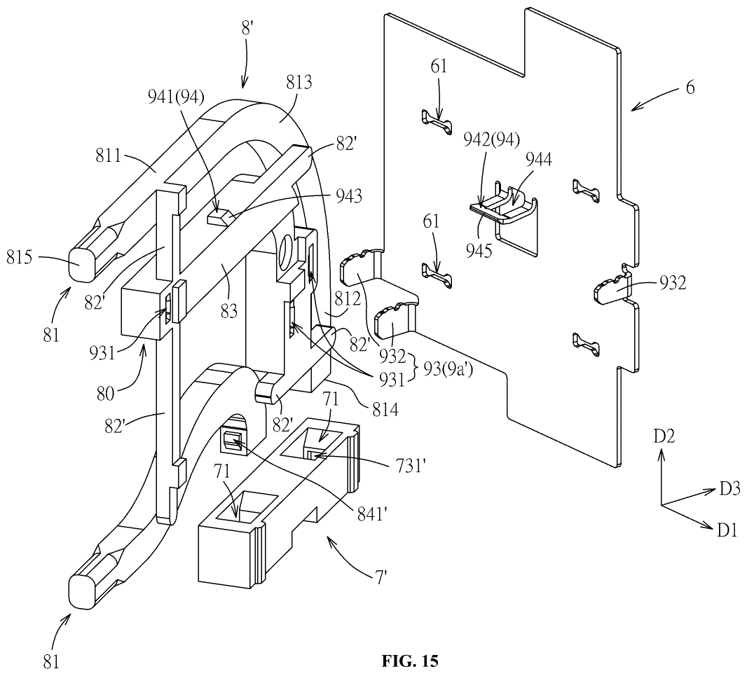

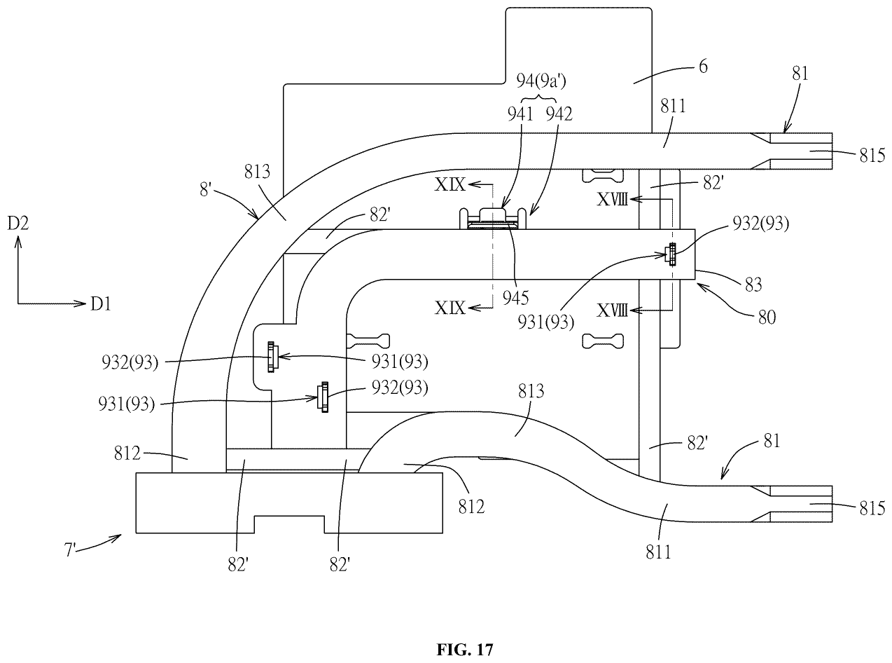

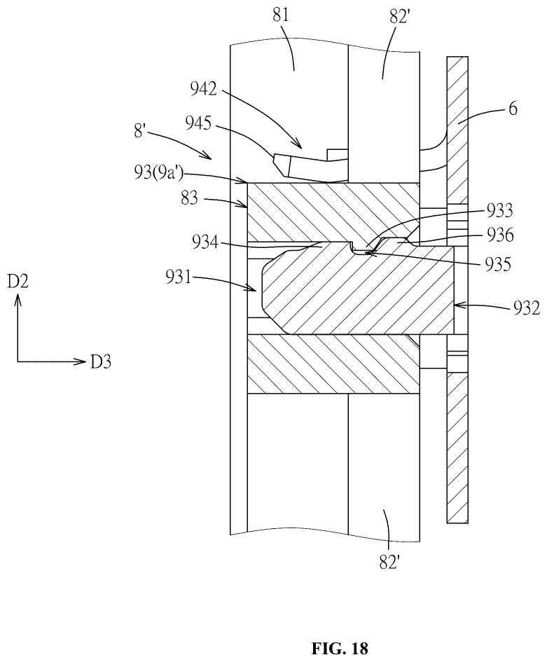

Referring to FIG. 14, FIG. 15, FIG. 17 and FIG. 18, when assembled, the light guide member 8′ is capable of being assembled to the side cover plate 6 in an assembling direction that the light guide member 8′ faces the side cover plate 6 (that is, in the left-right direction D3 toward a direction that the light guide member 8′ is close to the side cover plate 6) and in a manner that the plurality of retaining holes 931 of the light guide member 8′ are respectively aligned with the plurality of retaining pieces 932, in this way, as shown in FIG. 18, in the assembling direction that the light guide member 8′ faces the side cover plate 6, the plurality of retaining pieces 932 are respectively fixed in the plurality of the retaining hole 931 with interference cooperation, so as to increase the retention force that the light guide member 8′ is retained on the side cover plate 6.

In a process that the retaining piece 932 inserts into the retaining hole 931, one end of the retaining piece 932 adjacent to an opening the retaining hole 931 is defined as front, the other end of the retaining piece 932 adjacent to the side cover plate 6 is defined as rear. An upper side edge of each retaining piece 932 has a front protruding portion 934, a recessed portion 935 positioned behind the front protruding portion 934, and a rear protruding portion 936 positioned behind the recessed portion 935. Specifically, the front protruding portion 934 and the rear protruding portion 936 of each retaining piece 932 are arranged front and rear along an inserting direction that the retaining piece 932 inserts into the retaining hole 931 and are provided to the upper side edge of the retaining piece 932, the recessed portion 935 is positioned between the front protruding portion 934 and the rear protruding portion 936. Moreover, a height of the rear protruding portion 936 that the rear protruding portion 936 protrudes upwardly in the up-down direction D2 is larger than a height of the front protruding portion 934 that the front protruding portion 934 protrudes upwardly in the up-down direction D2. Each retaining hole 931 therein has an internal protruding portion 933 which protrudes downwardly from a top portion of an inner wall of the retaining hole 931 toward an interior of the retaining hole 931 and cooperates with the recessed portion 935 of the upper side edge of the retaining piece 932.

In a process that the light guide member 8′ is assembled into the side cover plate 6, firstly, the plurality of retaining holes 931 are respectively aligned with the plurality of retaining pieces 932; next, the plurality of retaining holes 931 respectively allow the plurality of retaining pieces 932 to insert therein in a direction which the plurality of retaining pieces 932 are toward the plurality of retaining hole 931 (parallel to extending directions of plurality of the retaining holes 931 and extending directions of plurality of the retaining pieces 932), during insertion, the front protruding portion 934 firstly interferes with scratches the internal protruding portion 933, although the internal protruding portion 933 is partially scratched, the internal protruding portion 933 still substantially maintains as a protruding block to pass over the front protruding portion 934 and then enters into the recessed portion 935, in turn is limited by the front protruding portion 934 and the rear protruding portion 936. Similarly, when the retaining piece 932 withdraws from the retaining hole 931, the internal protruding portion 933 will scratch the front protruding portion 934 again, and still maintain as a protruding block to pass over the front protruding portion 934, in this way, it is beneficial for the retaining hole 931 to be capable of being assembled and used again. In addition, besides that the front protruding portion 934 of the retaining piece 932 generates interference with the internal protruding portion 933 in the retaining hole 931 in the inserting process of the retaining piece 932, the front protruding portion 934 further may be provided to interfere with the inner wall of the retaining hole 931, in this way, it is capable of further increasing the retention force that the light guide member 8′ is retained on the side cover plate 6. Further, the rear protruding portion 936 also may be provided to interfere with the inner wall of the retaining hole 931. The front protruding portion 934, the recessed portion 935 and the rear protruding portion 936 of the embodiment are positioned to the same side (an upper side) of the retaining piece 932, but also may be provided to each of two sides (the upper side and a lower side) of the retaining piece 932, the top portion and a bottom portion of the inner wall of the retaining hole 931 also may be respectively with the corresponding internal protruding portions 933 which protrude toward the interior of the retaining hole 931.

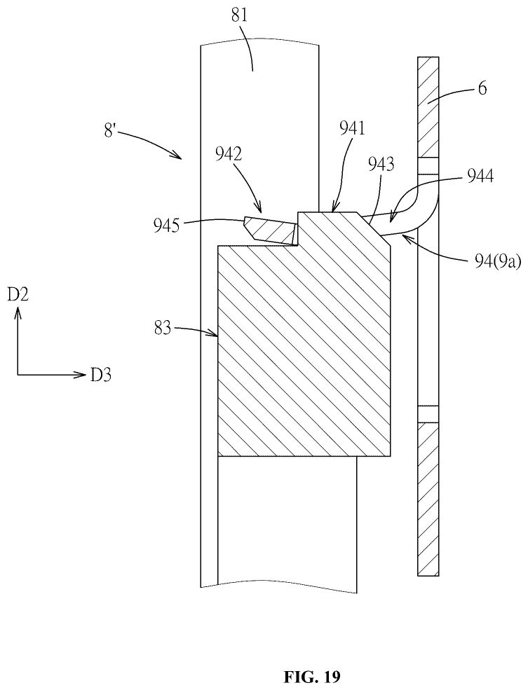

Referring to FIG. 13 to FIG. 15, FIG. 17 and FIG. 19, the elastic latching construction 94 has a latch block 941 which is provided to the light guide member 8′, and a latch piece 942 which is provided to the side cover plate 6 and is elastic. Specifically, the latch block 941 protrudes upwardly from a top surface of the supporting rod 83. The latch piece 942 extends from the side cover plate 6 toward the light guide member 8′, and has a latch hole 944 which penetrates an upper surface and a lower surface of the latch piece 942. The latch hole 944 allows the latch block 941 to enter therein from down to up, is used to latch the latch block 941. As shown in FIG. 19, preferably, the latch block 941 has a guiding surface 943 which faces the latch piece 942 in the assembling process, that is, the guiding surface 943 obliquely extends toward the latch piece 942 and toward the down. A side of the latch piece 942 further has a guiding edge 945 which faces the latch block 941 and cooperates with the guiding surface 943 in the assembling process. A bottom surface of the guiding edge 945 obliquely extends toward the latch block 941 and toward the up.

Referring to FIG. 14, FIG. 15, FIG. 17 and FIG. 19, in the assembling process, the light guide member 8′ moves toward the side cover plate 6 and approaches the side cover plate 6 in the assembling direction that the light guide member 8′ faces the side cover plate 6 (that is, in the left-right direction D3 toward a direction that the light guide member 8′ is close to the side cover plate 6) and in a manner that the latch block 941 is aligned with the latch piece 942, at this time, the guiding edge 945 of the latch piece 942 will firstly slide upwardly along the guiding surface 943 of the latch block 941, which makes the latch piece 942 elastically deformed; next, the light guide member 8′ moves continuously to make the latch hole 944 of the latch piece 942 aligned with the latch block 941 so that the latch block 941 enters into the latch hole 944 and the latch piece 942 latches the latch block 941.

Referring to FIG. 13 to FIG. 16, in combination with the description as above, in the second embodiment, the light guide member 8′ is detachably assembled and fixed on the side cover plate 6 in a direction which complies with the surface of the side cover plate 6 by the first assembling construction 9a′ which is different in structure, and the light guide member 8′ is detachably assembled on the base seat 7′ by the second assembling construction 9b′.

In conclusion, by that the light guide member 8, 8′ is provided on the side cover plate 6, the corresponding side wall 113 of the guiding shield cage 1 does not need a construction and apertures which are used to assemble the light guiding pipe 81, at the same time by that the side cover plate 6 is assembled to the corresponding side wall 113 of the guiding shield cage 1, the side cover plate 6 is capable of covering some openings or opened holes on the side wall 113, the side cover plate 6 has a double technical effect of both an electromagnetic interference (EMI) shielding function and being used to assemble the light guide member 8, 8′. Moreover, by that the light guide member 8, 8′ and the side cover plate 6 are provided therebetween with the first assembling construction 9a, 9a′ which allows the light guide member 8, 8′ and the side cover plate 6 to cooperate with each other and the light guide member 8, 8′ and the base seat 7, 7′ are provided therebetween with the second assembling construction 9b, 9b′ which allows the light guide member 8, 8′ and the base seat 7, 7′ to cooperate with each other, the light guide member 8, 8′ and the base seat 7, 7′ are capable of being stably and indeed fixed on the side cover plate 6. Furthermore, by that the base seat 7 and the side cover plate 6 are provided therebetween with the third assembling construction 9c which allows the base seat 7 and the side cover plate 6 to cooperate with each other, strength and stability of unitary assembling of the light guide member 8 can be further increased. Moreover, by that the light guide member 8 and the side cover plate 6 therebetween include the inserting construction 91 and the clipping construction 92, the light guide member 8 is capable of being more firmly fixed, and the light guide member 8 is further capable of being detached. Moreover, by that the light guide member 8′ and the side cover plate 6 therebetween include the interference cooperating construction 93 and the elastic latching construction 94, the light guide member 8′ is capable of being more firmly fixed, and the light guide member 8′ is further capable of being detached. Moreover, by that in a process that the retaining piece 932 inserts into the retaining hole 931, the front protruding portion 934 firstly interferes with and scratches the internal protruding portion 933, although the internal protruding portion 933 is partially scratched but still substantially maintains as a protruding block to pass over the front protruding portion 934 and then enters into the recessed portion 935, in turn is limited by the front protruding portion 934 and the rear protruding portion 936, conversely, when the retaining piece 932 withdraws from the retaining hole 931, the internal protruding portion 933 will scratch the front protruding portion 934 again and still maintains as a protruding block to pass over the front protruding portion 934, in this way, it is beneficial for the retaining hole 931 to be capable of being assembled and used again. On the other hand, the light guide member 8, 8′ is provided to the outer side of the corresponding side wall 113, a sideward space is saved, at the same time the light guide member 8, 8′ is capable of being assembled and detached in the up-down direction or in the assembling direction that the light guide member 8, 8′ faces the side cover plate 6, particularly in a combination that a plurality of connector assemblies 100 are arranged side by side, a plurality of the guiding shield cages 1 are capable of being compactly arranged, so the object of the present disclosure can be indeed achieved.

However, the above description is only for the embodiments of the present disclosure, and it is not intended to limit the implementing scope of the present disclosure, and the simple equivalent changes and modifications made according to the claims and the contents of the specification are still included in the scope of the present disclosure.

1. A connector assembly, comprising:
a guiding shield cage comprising a side wall;
a side cover plate assembled to the side wall of the guiding shield cage;
a light guide member having a plurality of light guiding pipes, each light guiding pipe having a light inputting end and a light outputting end, the light guide member being assembled on the side cover plate; and
a first assembling construction provided between the light guide member and the side cover plate and used to assemble the light guide member on the side cover plate.

2. The connector assembly of claim 1, wherein
the first assembling construction has an inserting construction and a clipping construction.

3. The connector assembly of claim 2, wherein
the inserting construction has an inserting rod which is provided to the light guide member, and an inserting rod receiving groove which is formed to the side cover plate and is used to receive the inserting rod.

4. The connector assembly of claim 3, wherein
the light guide member further has a connecting rod which is connected between the plurality of light guiding pipes;
the inserting rod is provided on the connecting rod of the light guide member;
the side cover plate is constructed with a sideward protruding piece which extends outwardly,
the sideward protruding piece and a body of the side cover plate therebetween constitute the inserting rod receiving groove.

5. The connector assembly of 2, wherein
the clipping construction has a positioning block, a position-limiting block and a supporting block which are provided on the light guide member, and a positioning recess and a position-limiting groove which are provided on the side cover plate;
the positioning block is received in the positioning recess,
the position-limiting block inserts into the position-limiting groove,
the supporting block is supported on the side cover plate.

6. The connector assembly of claim 5, wherein
the light guide member further has a connecting rod which is connected between the plurality of light guiding pipes;
the positioning block, the position-limiting block and the supporting block are provided to the connecting rod of the light guide member which is close to the light outputting ends,
the positioning block protrudes toward the side cover plate,
above and below the positioning block each are provided with the position-limiting block which extends toward the front,
the supporting block extends rearwardly.

7. The connector assembly of claim 6, wherein
the side cover plate is constructed with a U-shaped protrusion which is opened upwardly, and a bulge which is positioned above the U-shaped protrusion,
the U-shaped protrusion and the bulge therebetween constitute the positioning recess;
the side cover plate comprises position-limiting pieces which extend outwardly and rearwardly, the position-limiting pieces and the body of the side cover plate therebetween constitute the position-limiting grooves.

8. The connector assembly of claim 1, wherein
the connector assembly further comprises a base seat and a second assembling construction,
the base seat is assembled on the light guide member, the base seat has a plurality of light guiding pipe receiving holes, the plurality of light guiding pipe receiving holes are respectively used to receive the light inputting ends of the plurality of light guiding pipes;
the second assembling construction is provided between the light guide member and the base seat.

9. The connector assembly of claim 8, wherein
the second assembling construction comprises a latching block which is provided on the light guide member, and a latching groove which is provided on the base seat and is used to latch with the latching block.

10. The connector assembly of claim 9, wherein
the light guide member further has connecting rods which are connected between the plurality of light guiding pipes;
the latching block is provided on the connecting rod of the light guide member which is close to the light inputting ends, the latching block extends downwardly and has a latching hook which is positioned to a tip of the latching block;
the latching groove is provided therein with a latching hook cooperating portion which cooperates with the latching hook.

11. The connector assembly of claim 9, wherein
the connector assembly further comprises a third assembling construction,
the base seat is assembled to the side cover plate,
the third assembling construction is provided between the base seat and the side cover plate.

12. The connector assembly of claim 11, wherein
the third assembling construction comprises a retaining groove which is provided to the base seat, and a retaining portion which is provided to the side cover plate and is used to insert into the retaining groove.

13. The connector assembly of claim 12, wherein
an opening of the retaining groove is positioned to a bottom surface of the base seat and the retaining groove extends upwardly from the opening;
the retaining portion upwardly extends to an outer side of a body of the side cover plate, and the retaining portion has an interfering protrusion which cooperates with the retaining groove by interference.

14. The connector assembly of claim 1, wherein
the first assembling construction has an interference cooperating construction and an elastic latching construction.

15. The connector assembly of claim 14, wherein
the interference cooperating construction has a retaining hole which is formed to the light guide member, and a retaining piece which is provided to the side cover plate,
in an assembling direction that the light guide member faces the side cover plate, the retaining piece is fixed in the retaining hole by interference cooperation.

16. The connector assembly of claim 15, wherein
a side edge of the retaining piece has a front protruding portion and a recessed portion which is positioned behind the front protruding portion,
the retaining hole therein has an internal protruding portion which cooperates with the recessed portion of the side edge of the retaining piece,
the front protruding portion interferes with the internal protruding portion in the retaining hole in an inserting process of the retaining piece.

17. The connector assembly of claim 16, wherein
the side edge of the retaining piece further has a rear protruding portion which is positioned behind the recessed portion,
the recessed portion is positioned between the front protruding portion and the rear protruding portion.

18. The connector assembly of 15, wherein
the elastic latching construction has a latch block which is provided to the light guide member, and a latch piece which is provided to the side cover plate and is elastic,
in the assembling direction that the light guide member faces the side cover plate, the latch piece latches the latch block.

19. The connector assembly of claim 18, wherein
the light guide member further has a supporting portion which is integrally connected to the plurality of light guiding pipes,
the supporting portion of the light guide member is formed with the retaining hole and the latch block.

20. The connector assembly of claim 19, wherein
the supporting portion comprises a supporting rod and a plurality of connecting rods connected to the plurality of light guiding pipes,
the supporting rod of the light guide member is formed with the retaining hole, and allows the latch block to be provided thereon.

21. The connector assembly of claim 20, wherein
the latch piece has a latch hole which is used to latch the latch block.

22. The connector assembly of claim 20, wherein
a side of the latch block which faces the latch piece is provided with a guiding surface,
a side of the latch piece which faces the latch block is provided with a guiding edge which cooperates with the guiding surface.

23. The connector assembly of claim 14, wherein
the connector assembly further comprises a base seat and a second assembling construction,
the base seat comprises a plurality of light guiding pipe receiving holes, the plurality of light guiding pipe receiving holes are respectively used to receive light inputting ends of the plurality of the light guiding pipes;
the second assembling construction is provided between the light guide member and the base seat.

24. The connector assembly of claim 23, wherein
the second assembling construction comprises a plurality of latching blocks which are respectively provided to the light inputting ends of the plurality of the light guiding pipes, and a plurality of latching grooves which are respectively formed to inner walls of the plurality of light guiding pipe receiving holes of the base seat,
the plurality of latching blocks respectively latch the plurality of the latching groove.

25. The connector assembly of claim 1, wherein
the guiding shield cage further comprises an assembling piece which protrudes from the side wall,
the side cover plate has an assembling hole,
the assembling piece passes through the assembling hole of the side cover plate, and latches the side cover plate.

26. The connector assembly of claim 25, wherein
the guiding shield cage further comprises a partitioning frame,
the partitioning frame has the assembling piece,
the side wall has an assembling hole,
the assembling hole of the side cover plate corresponds to the assembling hole of the side wall,
the assembling piece outwardly and sequentially passes through the assembling hole of the side wall and the assembling hole of the side cover plate, and latches the side cover plate.

27. The connector assembly of claim 8, wherein
the base seat of material is a soft material containing a rubber.
